(19) United States
(12) Patent Application Publication
(10) Pub. No.: US 2007/0039636 A1
(43) Pub. Date: Feb. 22, 2007

(54) Device for placing silverware in dishwashers

(75) Inventors: Gerhard Egger, Altenmunster (DE); Bernd Schessl, Dillingen/Donau (DE); Rainer Schutz, Neresheim (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERATE GMBH, Munchen (DE)

(21) Appl. No.: 10/575,612

(22) PCT Filed: Oct. 15, 2004
(86) PCT No.: PCT/EP04/52553

§ 371 Date: Apr. 11, 2006

(30) Foreign Application Priority Data
Oct. 15, 2003 (DE) 103 47 973.2

(51) Int. Cl. B08B 3/00; B08B 3/12

(52) U.S. Cl. 134/56 D; 134/201

(57) ABSTRACT

A dishwasher includes a device for placing pieces of silverware, which makes it possible to dispose the pieces of silverware in an easily accessible, compact, and careful manner in the washing compartment while keeping production costs low. The dishwasher includes a washing container, at least one crockery basket, and the device for receiving items to be washed, with the device being arranged on an exterior side of the crockery basket. The dishwasher has the advantage of requiring no additional tray for placing the pieces of silverware, thus reducing production costs. The inventive device for placing pieces of silverware is particularly suitable for use in a built-in dishwasher.

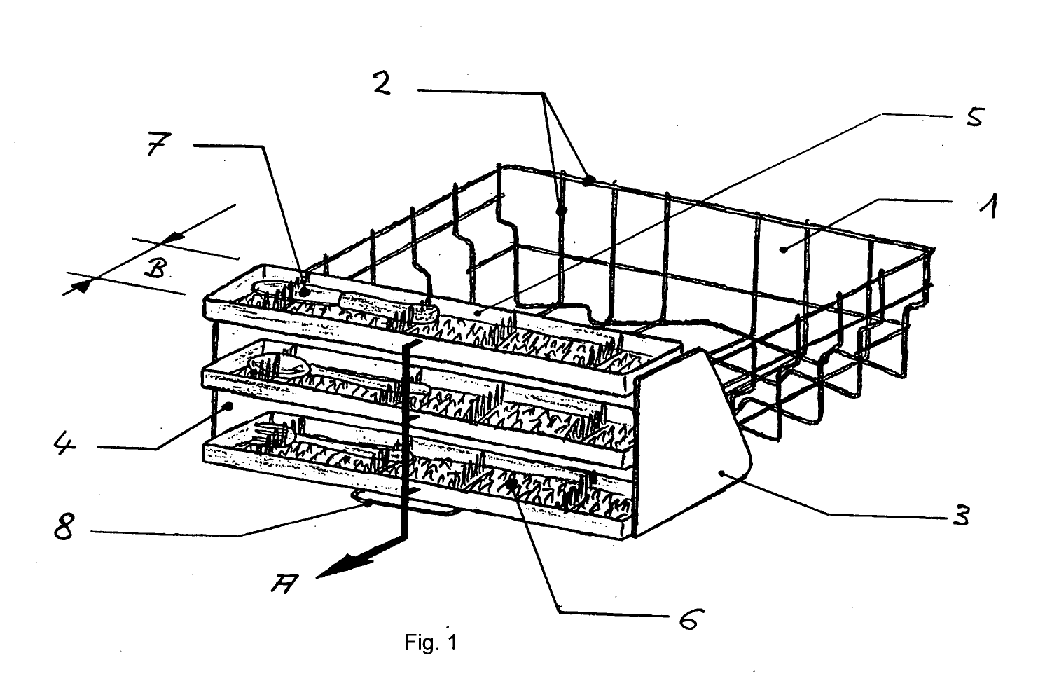

The invention relates to a dishwasher comprising a device for placing items to be washed, especially for placing pieces of silverware.

It is known to arrange items for washing in the washing container of a dishwasher in one or a plurality of crockery baskets. These crockery baskets usually consist of a wire mesh and are usually mounted displaceably on the side walls of the washing container so that when the front door of a built-in dishwasher is opened, they can be withdrawn from the washing container. In order to accommodate pieces of silverware, a separate module is frequently provided in the lower crockery basket and this can usually be removed from the crockery basket. A disadvantage of this known separate module is that the pieces of silverware can only be loosely accommodated therein and come into contact with one another, which can result in damage to the pieces of silverware and the development of noise during the washing operation.

It is further known to provide additional knife racks in the area of the upper crockery basket on which the pieces of silverware can be placed. These additional knife racks have the disadvantage that they take up a large amount of space in the crockery basket which is therefore lost for accommodating other items for washing. In a further known device for placing pieces of silverware, a cutlery drawer is provided in addition to the crockery baskets and can be slid in and out in the washing container of the dishwasher. However, cutlery drawers have the disadvantage that they cannot accommodate large pieces of silverware; in addition, the manufacturing costs of the dishwasher are increased by installing an additional drawer.

It is thus the object of the invention to provide a dishwasher with a device for placing items of silverware which overcomes the aforesaid disadvantages and makes it possible to accommodate the pieces of silverware in an easily accessible, compact and careful manner in the washing compartment whilst keeping production costs low.

These objects are solved by the dishwasher according to the invention having the features according to claim 1. Advantageous further developments of the present invention are characterised in the dependent claims 2 to 11.

The dishwasher according to the present invention has at least one crockery basket comprising a device for placing items to be washed, especially for placing items of silverware, said device being arranged on an exterior side of the crockery basket.

The dishwasher according to the invention has the advantage that no additional drawer is required to accommodate the pieces of silverware which reduces production costs. Furthermore, in the dishwasher according to the invention the pieces of silverware are easily accessible on the exterior side of the crockery basket, especially when the device for placing pieces of silverware is located on the front side of a displaceably mounted crockery basket which can be pulled out from the washing container of a built-in dishwasher via this front side.

Since the device for placing pieces of silverware is located on the exterior side of the crockery basket in the dishwasher according to the invention, the pieces of silverware can be arranged in a particularly space-saving manner and the inner region of the crockery basket can be used exclusively for placing other items to be washed. The arrangement of the device for placing items of silverware on the exterior side of the crockery basket further has the advantage that the entire height of the crockery basket is available for stowing items of silverware so that large and bulky items of silverware or other items to be washed can be stored therein.

In an advantageous embodiment of the present invention, the device comprises at least one storage compartment with a substantially horizontal tray area on which the pieces of silverware can be arranged clearly in a horizontal position.

It is especially advantageous if the device has two lateral flange plates which are preferably detachably connected to the crockery basket and on which at least one storage compartment is mounted. As a result, the device can be separated from the crockery basket entirely if required, for example, for the purpose of arranging or removing the pieces of silverware. It is likewise possible for at least one storage compartment to be removed from the device and re-inserted in the device since the storage compartment is detachably mounted on the lateral flange plates to facilitate the loading of the device or the removal of items of silverware from the device.

More appropriately, at least one storage compartment can be inserted in the device in different positions at different heights. For this purpose a plurality of mountings for the storage compartment can be provided at different heights in the lateral flange plates of the device. In this way, on the one hand the adjusting height of the storage compartment can be matched to the size of the items of silverware to be accommodated therein and on the other hand, the space requirement for the items to be washed in the upper or lower crockery basket of the dishwasher can be taken into account.

In a further advantageous embodiment of the present invention, the device comprises a plurality of storage compartments preferably arranged substantially above one another, wherein the storage compartments are more appropriately arranged substantially step-wise so that a lower storage compartment respectively projects over an upper storage compartment at least partly in the horizontal direction. Such an arrangement not only allows optimal usage of the entire height of the crockery basket on which the device for placing items of silverware is arranged but also allows easy access to the storage compartments.

More appropriately, at least one storage compartment is provided with accessories for suitable arrangement and storage of the pieces of silverware on the tray area which promotes separation of the items of silverware and their cleaning during washing operation of the dishwasher. As a result, a clear arrangement of the items of silverware in certain positions in the device can be achieved and any contact of the items of silverware can be prevented, preventing damage to the items of silverware or development of noise during washing operation.

For this purpose, the accessories for suitable arrangement and storage of the pieces of silverware on the tray area comprise projections which protrude vertically and/or obliquely from the tray area. These projections are preferably constructed so that they are specially adapted in certain areas of the tray area for the placement of specific items of silverware, such as knives, forks or spoons for example.

Especially in built-in dishwashers, for easy handling of the dishwasher according to the invention the device can be provided with a handle by which means the preferably displaceably mounted crockery basket can be moved. Alternatively or additionally, the crockery basket can also be provided with a handle which protrudes beyond the device at least partly in the horizontal direction wherein the preferably displaceably mounted crockery basket can be withdrawn from the washing container by means of the handle.

The present invention is explained in detail hereinafter with reference to the drawings. The drawing shows a perspective view of a crockery basket for a dishwasher according to the invention comprising a device for placing items to be washed, especially for placing pieces of silverware.

In detail the drawing shows a crockery basket 1 which is preferably displaceably mounted in the washing container of a built-in dishwasher according to the invention so that the crockery basket 1 can be withdrawn from the washing container in the horizontal direction A when the front door of the dishwasher (not shown) is opened. Attached to the exterior front side of a crockery basket 1 is a device 3, 4, 5 for placing items to be washed, especially for placing items of silverware 7, which in the present exemplary embodiment comprises three storage compartments 5 arranged above one another, with substantially horizontal storage trays for the items of silverware 7. The storage trays have a width B which allows a plurality of items of silverware 7 to be arranged next to one another.

The device is preferably detachably connected to the crockery basket 1 by means of two lateral flange plates 3, 4. Storage compartments 5 are preferably mounted between the flange plates 3, 4 such that the storage compartments 5 can each be removed from their holders and re-inserted. More advantageously, a plurality of holders for the storage compartments 5 are provided at different heights in the flange plates 3, 4 so that the storage compartments 5 can be inserted at different heights in the device according to the space requirement for the items for washing to be stowed.

It is especially advantageous if the storage compartments 5 are arranged substantially stepwise above one another so that the lower storage compartment respectively projects over the upper storage compartment at least partly in the horizontal direction A. In this way, the storage trays of the storage compartments 5 are easily viewed and the storage compartments 5 can easily be removed from the device and re-inserted.

Accessories for suitable arrangement and storage of the items of silverware 7 are provided on the storage tray of the storage compartments 5, these accessories comprising projections 6 protruding vertically and/or obliquely from the storage tray. These projections 6 are preferably constructed to that in certain areas of the tray area they are specially adapted for placement of certain items of silverware, such as for example knives, forks or spoons.

The device is provided with a handle 8 which can be used to withdraw the crockery basket 1 from the washing container in the horizontal direction A. However, the handle 8 can also be connected directly to the crockery basket 1, for example, in the form of a wire clip or it can be constructed as part of the crockery basket 1, where the handle 8 projects at least partly over the device 3, 4, 5 in the direction A for better operability.

1-11. (canceled)

12. A dishwasher comprising:
a washing container;
at least one crockery basket; and
a device for receiving items to be washed, the device being operable to receive at least one of silverware and non-silverware items and the device being arranged on an exterior side of the crockery basket.

13. The dishwasher according to claim 12, wherein the device has at least one storage compartment with a substantially horizontal tray area.

14. The dishwasher according to claim 12, wherein the device has two lateral flange plates and at least one storage compartment mounted to the lateral flange plates, the lateral flange plates being connected to the crockery basket by a selected one of a detachable connection and a non-detachable connection.

15. The dishwasher according to claim 14, wherein the at least one storage compartment can be removed from the device and can be re-inserted in the device.

16. The dishwasher according to claim 15, wherein the at least one storage compartment can be inserted in the device in different positions at different height.

17. The dishwasher according to claim 12, wherein the device has a plurality of storage compartments arranged in a selected one of an arrangement in which the storage compartments are substantially above one another and an arrangement in which the storage compartments are not substantially above one another.

18. The dishwasher according to claim 17, wherein the storage compartments are arranged substantially step-wise so that a lower storage compartment respectively projects over an upper storage compartment at least partly in the horizontal direction.

19. The dishwasher according to claim 12, wherein the device has at least one storage compartment having a tray area and the at least one storage compartment has accessories for suitable arrangement and storage of pieces of silverware on the tray area.

20. The dishwasher according to claim 19, wherein the accessories for suitable arrangement and storage of the pieces of silverware on the tray area comprise projections that protrude a selected one of vertically and obliquely from the tray area.

21. The dishwasher according to claim 12, wherein the device has a handle by means of which the crockery basket can be moved and the crockery basket is a selected one of displaceably mounted and not displaceably mounted.

22. The dishwasher according to claim 21, wherein the handle protrudes beyond the device at least partly in the horizontal direction.
